(19) United States
(12) Patent Application Publication
(10) Pub. No.: US 2017/0120884 A1
(43) Pub. Date: May 4, 2017

(54) Brake Wear Analysis System

(71) Applicant: Caterpillar Inc., Peoria, IL (US)

(72) Inventors: Edward W. Mate, Manhattan, IL (US); Zhangong Du, Naperville, IL (US); Shinya Sono, Naperville, IL (US)

(73) Assignee: Caterpillar Inc., Peoria, IL (US)

(21) Appl. No.: 14/932,671

(22) Filed: Nov. 4, 2015

(51) Int. Cl. B60T 17/22; F16D 66/02

(52) U.S. Cl. CPC B60T 17/221; F16D 66/02; B60T 2270/88; B60T 2270/40

(57) ABSTRACT

A brake wear analysis system is presented for use within a work machine. The brake wear analysis system includes a brake charge system as well as at least one accumulator connected to the brake charge system. The at least one accumulator operable to flow a fluid from the accumulator to a brake control valve based on an executed braking action. A change of pressure within the at least one accumulator being received by a pressure sensor connected to the brake charge system and transmitted to a brake wear analysis module within the controller of the work machine. The brake wear analysis module being configured to compare the flow of fluid from the at least one accumulator with a predetermined condition resulting in a determination of whether or not a braking mechanism of the work machine is functioning in a worn condition.

### TECHNICAL FIELD

The present disclosure generally relates to the braking system of a work machine, and more particularly relates to an analysis system to determine a wear condition of the brakes of such a braking system.

### BACKGROUND

Earthmoving and work machines are used in a variety of industries including construction, mining, forestry, and other similar industries. Such work machines often employ hydraulic systems that provide functionality and control the various aspects of the machines. The hydraulic systems on the work machines may include braking systems to control driving speed, fan hydraulic drive systems to control machine cooling, and drive operation systems to control machine attachments such as tools, buckets, and loaders. Each hydraulic system of a work machine is generally an isolated system. These systems may have separate flow requirements, each with a separate fluid pump. In some other operational scenarios, the hydraulic systems may be combined, yet each separate system may have independent fluid-flow parameters and requirements.

Work machines commonly employ a hydraulic system as the main braking system. These systems are adapted to respond to an input from a user to perform a braking action of the work machine. Usually within these machines, a user input is applied via a brake pedal or the like signaling the hydraulic brake system to operate. Accumulators flow hydraulic fluid into the hydraulic braking system to perform a braking action depending on the input of the user.

Over the work life cycle of a work machine, these braking actions are applied numerous times. Each individual braking action causes the actual braking component to be in contact with a driven wheel of the work machine to perform the physical braking. This contact gradually wears the physical components of the braking system each time a braking action is applied. Over extended work periods, these physical components need to be replaced via maintenance on the work machines.

Various work machines, utilize a multitude of braking mechanisms to slow and stop their respective work machines. Such braking mechanisms range from disc brakes and drum brakes (which press against a wheel plate to slow the work machine), to clamps and friction pads (used to slow the rotation of either the front or rear axles of a work machine). The braking mechanisms contacting either the axles or wheels to be braked usually include a wearable disc or pad which provides the friction needed for the braking action. Over time, this wearable disc or pad disintegrates from the friction used to brake the work machine. Eventually this will lead to the replacement of the braking mechanisms so that the braking system of the work machine can properly function. Knowing when the braking mechanisms have been sufficiently worn to warrant replacement is an inexact science. Currently, maintenance technicians will periodically check the wear of these braking mechanisms to see if replacements are needed. Although maintenance checks are scheduled at regular intervals during the work life cycle of the work machine, it would be helpful to know when maintenance is required before such a scheduled visit. Additionally, this allows the maintenance technicians to address simple maintenance issues which, if not detected early, may lead to a more significant failure of the braking system 200 through extended use.

To address the wear condition of the brakes within a work machine alternate systems have been developed. Such a system may be seen in Indian Patent Application IN20120121714. In this application, a method and apparatus to detect fault within an automobile braking system is disclosed. This method and apparatus uses vibration analysis on the components of the braking system to help determine if any faults or errors have occurred. Although this technique may be beneficial for automobiles, new electronics must be introduced to the braking system to create and detect vibrations through the braking system components. For work machines, this system may not be as beneficial as work machines include many open spaces where foreign matter may attach and affect the recorded vibration signals thereby providing false positive readings.

Traditionally, to determine whether or not the physical components of the braking system have deteriorated to the point of replacement, visual inspection by a technician of the maintenance team is usually needed. It would be advantageous to not only the maintenance team, but also to the operator of a work machine, to be notified if the physical components of the braking system are ready for replacement before actual maintenance occurs.

### SUMMARY OF THE DISCLOSURE

In one aspect of the disclosure, a brake wear analysis system is disclosed for use on a work machine. The brake wear analysis system may have a brake charge system and at least one accumulator connected to the brake charge system. The at least one accumulator may be able to store a pressurized fluid received from the brake charge system. A brake control valve would then be able to receive the stored pressurized fluid from the at least one accumulator based on an input indicative of a braking action. Additionally, at least one pressure sensor may be fluidly coupled to the brake charge system to indicate an accumulator pressure of the pressurized fluid of the at least one accumulator. A controller would then be connected to the at least one pressure sensor. The controller may have a brake wear analysis module and a braking algorithm configured to receive and interpret the information regarding the braking action sent from the at least one pressure sensor. The controller may be configured to receive a pressure signal from the at least one pressure sensor and determine the accumulator pressure in response to the input indicative of the braking action. Then, the controller may determine an estimated volume of fluid received by the brake control valve with the braking algorithm module based on the determined accumulator pressure. And finally, the controller may then compare the estimated volume with a predetermined threshold indicative of nominal worn brake volume with the brake wear analysis module.

In another aspect of the disclosure, a work machine is disclosed. The work machine may have a frame, and an operator station and a power source supported by the frame. Additionally, the work machine may have a drive system operatively connected to the power source and a brake system operatively connected to the drive system. The brake system may have at least one accumulator connected to the brake charge system. The at least one accumulator may be able to receive and hold a fluid from the brake charge system. A brake control valve would then connect to the at least one accumulator and receive the fluid from the at least one accumulator based on an input received within the operator station. Additionally, at least one pressure sensor may be connected to the brake charge system. The at least one pressure sensor may be able to receive and transmit information regarding a braking action applied to the drive system of the work machine. A controller would then be connected to the at least one pressure sensor. The controller may have a brake wear analysis module configured to receive and interpret the information regarding the braking action applied to the drive system sent from the at least one pressure sensor.

In yet another aspect of the disclosure, a method to determine the wear of a brake system is disclosed. First, an input to activate a braking action within the brake system of a work machine is provided. Then, a fluid may be provided from at least one accumulator to a brake control valve based on the provided input. Next, an accumulator pressure may be received with at least one pressure sensor based on the provided input. Then, a change in accumulator pressure may be determined with a controller as a result of the provided input. Next, a change in volume of the amount of fluid flow from the at least one accumulator of the brake control valve may be determined with a braking algorithm module of the controller based in part on the determined change in accumulator pressure. And finally, the brake wear analysis module then compares the amount of fluid flow from the at least one accumulator to the brake control valve with a predetermined condition stored within the brake wear analysis module.

These and other aspects and features of the present disclosure will be more readily understood when reading the following detailed description taken in conjunction with the accompanied drawings.

### BRIEF DESCRIPTION OF THE DRAWINGS

FIG. 1 is a side view of a work machine having a brake system in accordance with an embodiment of the present disclosure.

FIG. 2 is a schematic illustration of a hydraulic based brake charge system of the work machine in accordance with an embodiment of the present disclosure.

FIG. 3 is a block diagram of the controller contained within the work machine and connected to the brake charge system in accordance with an embodiment of the present disclosure.

FIG. 4 is a flow chart depicting a sample sequence of steps which may be executed by a brake wear analysis module contained within controller of the work machine in accordance with an embodiment of the present disclosure.

FIG. 5 is a flow chart showing a method to determine the wear of a brake system within a work machine in accordance with an embodiment of the present disclosure.

It should be understood that the drawings are not necessarily to scale and that the disclosed embodiments are illustrated diagrammatically and in partial views. It should be further understood that this disclosure is not to be limited to the particular embodiments illustrated herein.

### DETAILED DESCRIPTION

The present disclosure provides a brake wear analysis system 100 used in conjunction with a brake charge system 110 of a work machine 120. Examples of such work machines 120 include but are not limited to machines used for construction, earthmoving, mining, forestry, and other similar industries. Those skilled in the art will understand that the strategy in accordance with the present disclosure may be implemented in other types of work machines 120 as well. Moreover, references to various elements described herein, are made collectively or individually when there may be more than one element of the same type. However, such reference are rendered to merely aid the reader's understanding of the present disclosure and to be considered as exemplary. Accordingly, it may be noted that any such reference to elements in the singular is also to be construed to relate to the plural and vice versa without limiting the scope of the disclosure to the exact number or type of such elements unless set forth explicitly in the presented claims.

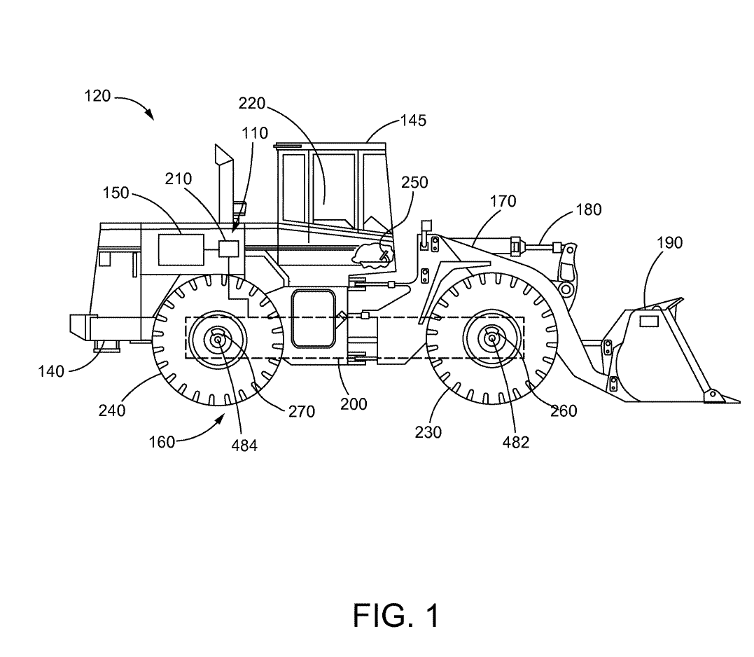

Referring now to the drawings and with specific reference to FIG. 1, a work machine 120 is presented. The work machine 120 may be a mobile machine that performs some type of operation associated with an industry, such as mining, construction, farming, transportation, or any other industry known to use work machines 120. In different embodiments, the work machine 120 may be a wheel loader (as depicted in FIG. 1), a motor grader, a backhoe, a scraper, a dozer, an excavator, an off-highway truck, an on-highway truck, or any other work machine 120 known in the art. The work machine 120, as viewed in FIG. 1, includes a frame 140, an operator station 145, a power source 150, a drive system 160, a lift arm 170, a lift cylinder (not shown), a tilt cylinder 180, a work tool 190, a brake system 200, and a controller 210.

The frame 140 may include any structural member or assembly of members that support movement of the work machine 120. Additionally, the frame 140 may be positioned to support the operator station 145. The operator station 145 may contain controls necessary to operate the work machine 120. These controls may include input devices (not shown) such has steering mechanisms and levers to propel the work machine 120 or other machine components. The input devices (not shown) may be adapted to receive input from the user operator to indicate the desired machine movement or operation of an attached work tool 190 to the work machine 120. These input devices not shown) may include a steering wheel, single or multi-axis joysticks, switches, knobs, or other known devices that are located proximate to the operator seat 220 within the operator station 145. Furthermore, these input devices (not shown) may be configured to generate and transmit control signals to the controller 210 of the work machine 120. These control signals may indicate a desired position of movement, force, velocity, and/or acceleration of the lift cylinder (not shown) and the tilt cylinder 180. The lift cylinder (not shown) and the tilt cylinder 180 may be operably coupled to the lift arm 170. The lift cylinder (not shown) and the tilt cylinder 180 connect to the frame 140 at one end and connect to the work tool 190 at a second end. Expansion of the lift cylinder (not shown) may result in elevation of the lift arm 170. Retraction of the lift cylinder (not shown) results in a lowering of the lift arm 170.

A power source 150 may also be supported by the frame 140 of the work machine 120. The power source 150 may be an engine, such as a diesel engine, a gasoline engine, a gaseous fuel-powered engine, a natural gas engine, or any other engine for use on a work machine 120. Alternatively, the power source 150 may consist of a non-combustion source of power, such as a fuel cell, a power storage device, or another suitable power source 150. The power source 150 may produce mechanical or electrical power output that may be converted to hydraulic power. The power source 150 may power the drive system 160 that may include a pair of front wheels 230 and a pair of rear wheels 240, positioned to support the work machine 120. The front wheels 230 and the rear wheels 240 may be rotated to steer and maneuver the work machine 120 in both a forward and reverse direction.

The work machine 120 further includes the brake system 200 which may be operatively connected to the controller 210. The brake system 200 may be configured to decelerate the movement of the work machine 120 when the work machine 120 is in motion. Furthermore, the controller 210 may be operatively connected to the power source 150, the drive system 160, the brake system 200, and the operator station 145. The controller 210 may also be adapted to receive signals from input devices (not shown) associated with the operator station 145. The controller 210 may monitor and provide appropriate output signals to various systems to control the movement of the work machine 120 and the work tool 190 or preform various other functions and tasks during operation.

Additionally, like the drive system 160, the brake system 200 may be associated with the front wheels 230 and the rear wheels 240. The brake system 200 may further be operable with other input devices such as a brake pedal 250 within the operator station 145. The brake system 200, in an embodiment of the present disclosure, may be hydraulically driven and include front brakes 260 and rear brakes 270. The front brakes 260 and rear brakes 270 may be operatively associated with the respective front wheels 230 and rear wheels 240 of the work machine 120. Also, the front brakes 260 and rear brakes 270 may selectively decelerate movement of the work machine 120. In one embodiment of the present disclosure, each of the front brakes 260 and the rear brakes 270 may include a hydraulic pressure-actuated wheel brake, such as a disk brake or a drum brake. The front brakes 260 and the rear brakes 270 are disposed intermediate to the front wheels 230 and the rear wheels 240 by a final drive assembly (not shown) of the work machine 120. When actuated, pressurized fluid within the front brakes 260 and the rear brakes 270 may increase the rolling friction of the work machine 120, which slows the movement of the work machine 120. The front brakes 260 and the rear brakes 270 may be operated by an input, such as but not limited to the brake pedal 250 positioned within the operator station 145. The brake pedal 250 may be associated with both the front brakes 260 and the rear brakes 270. As an operator depresses the brake pedal 250 along a braking range, pressurized fluid may be directed to the front brakes 260 and the rear brakes 270. The degree of depression by the brake pedal 250 proportionally controls the pressure of the fluid that is supplied to each the front brakes 260 and the rear brakes 270.

The brake system 200 may further include the brake charge system 110 that can be associated with at least one of the front brakes 260 or the rear brakes 270. The brake charge system 110 may include a plurality of fluid components and electrical components. The brake charge system 110 may be operatively connected to control the braking capacity of the brake system 200, thereby controlling the braking capacity of the work machine 120. In the illustrated embodiment, the brake charge system 110 is operatively connected to the controller 210. The controller 210 may then utilize programs to analyze information supplied from the brake charge system 110 to see if a wear condition is present within the mechanical components of the brakes. The brake charge system 110 may be adapted to drive other integrated hydraulic systems, such as a cooling system sharing a common fluid source or tank within the work machine 120. The fluid components and the electrical components of the brake charge system 110 may cooperate to control the braking and other capacities of the work machine 120.

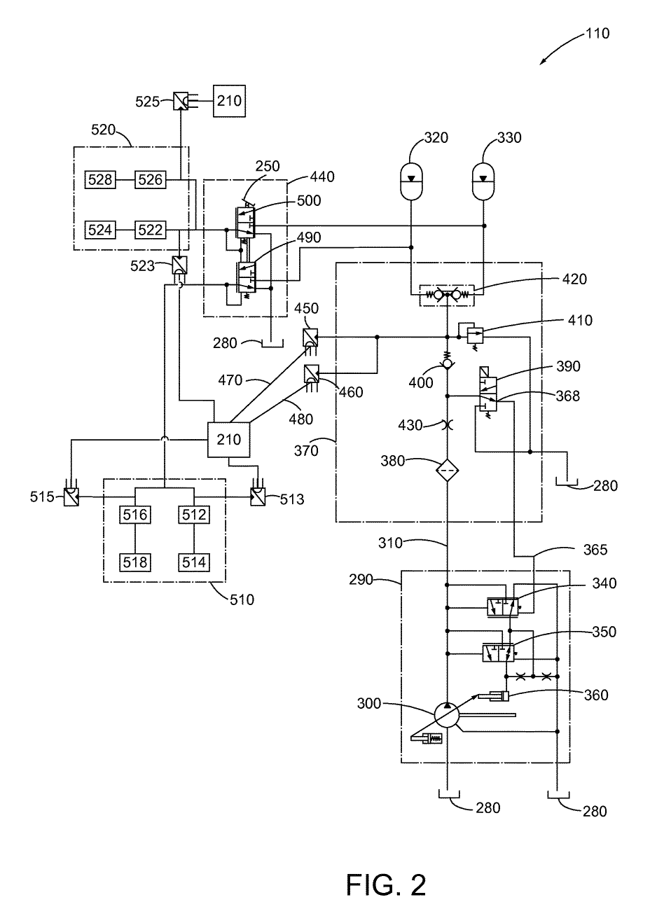

Referring now to FIG. 2, a schematic of the brake charge system 110 is depicted. A tank 280 may be present connecting to the brake charge system 110. The tank 280 may be any type of holding mechanism configured to contain a supply of fluid. The fluid may include, but is not limited to: dedicated hydraulic oil, transmission lubricated oil, or any other fluid known in the art. The brake charge system 110 is configured to draw fluid from and return fluid to the tank 280. One or more hydraulic systems of the work machine 120 may share the fluid within the tank 280 allowing those other systems to drawn and return the respective fluid to the tank 280. Additionally, one or more components of the brake charge system 110 may be operable to drawn and return fluid to the tank 280.

Also viewed in FIG. 2, a pump section 290 of the brake charge system 110 is present. In one example, the pump section 290 can have a pump 300 shown as a load-sensing pump configured to provide pressurized fluid to the brake charge system 110. The pump 300 may draw fluid from the tank 280 and supply pressurized fluid according to the parameters of the brake charge system 110. Then, the pump 300 will direct the pressurized fluid from pump 300 through a fluid flow path 310 into each of a first accumulator 320 and a second accumulator 330. In an exemplary embodiment of the present disclosure, the pump 300 may be a variable displacement piston pump with load-sensing capabilities. These load-sensing capabilities permit the pump 300 to operate or provide fluid flow only when necessary. This, in turn, improves the efficiency of the work machine 120. In another exemplary embodiment of the present disclosure, the pump 300 may be adapted to produce a flow of pressurized fluid proportional to a rotational input speed into the pump 300. This may allow the pump 300 to be directly driven by an electric motor (not shown). The pump 300 may or may not be a fixed delivery pump that delivers a constant flow rate of pressurized fluid per input revolution.

The pump 300 may be operated by at least one of the margin valve 340 and the high pressure cut-off valve 350. The margin valve 340 can be movable based on an accumulator pressure. For example, the margin valve 340 can be configured to take an accumulator pressure as a reference signal, or load-sense signal, via load-sense lines 365. The margin valve 340 can be adapted to add a margin pressure to the accumulator pressure and generate a margin valve output signal for the cylinder 360. Based on the margin valve output signal, which corresponds to the margin valve output pressure, the cylinder 360 actuates a swash plate of the pump 300. Accordingly, the pump 300 delivers the fluid to the supply valve 370 at a pressure output to maintain the margin between the discharge pressure and a load sense signal supplied by an electronic solenoid valve 390 of the supply valve 370. A margin drop occurs from flow of the fluid through a fixed orifice 430 coupling a supply passage formed in the supply valve 370 and in communication with the fluid flow path 310.

The high pressure cut-off valve 350 can have a predetermined cut-off pressure at which the high pressure cut-off valve 350 initiates operation. The predetermined cut-off pressure of the high pressure cut-off valve 350 may be set as a sum of spring biasing pressure and tank pressure. The high pressure cut-off valve 350 is configured to operate the pump 300 when the output pressure corresponds to the margin valve output pressure and exceeds the predetermined cut-off pressure. The high pressure cut-off valve 350 actuates the cylinder 360 to displace the pump 300 to deliver the fluid to a supply valve 370 at the output pressure equal to the predetermined cut-off pressure.

The supply valve 370 is located between pump 300 and each the first accumulator 320 and the second accumulator 330. The supply valve 370 may include one or more of the following: a filter 380 or a screen, the electronic solenoid valve 390, a check valve 400, a relief valve 410, and an inverse shuttle valve 420. The filter 380 or screen is located above the pump 300 within the supply valve 370. The filter 380 or screen allows the flow of fluid from the pump 300 to pass through the filter 380 and on into both the first accumulator 320 and the second accumulator 330. The filter 380 or screen operates to remove any impurities or foreign material from the fluid and clean the fluid so that the fluid can operationally flow through the valves and pump 300 of the brake charge system 110. The check valve 400 can be coupled to the fluid flow path 310 downstream of the filter 380. The check valve 400 allows the unidirectional flow of the fluid through the check valve 400 but does not allow the fluid to return in the opposite direction. Furthermore, the fixed orifice 430 is present between the check valve 400 and the filter 380 or screen. The fixed orifice 430 works with the pump margin of the pump 300 to set the flow rate of fluid to each the first accumulator 320 and the second accumulator 330. The change in pressure across the fixed orifice 430 determines the flow rate to both the accumulators 320 and 330. The pump 300 adjusts the output flow of the fluid to make sure the margin is dropped across the fixed orifice 430.

Still referring to FIG. 2, the electronic solenoid valve 390 or charging valve is coupled to a branch line that is coupled to the fluid flow path 310 between the fixed orifice 430 and the check valve 400. A load-sense line 365 can be extended between a load sense port 368 of the electronic solenoid valve 390 to the side of the margin valve 340. The electronic solenoid valve 390 is movable between two positions to connect the load sense port to either the pump pressure port (first position) or to the tank 280 (second position) based on accumulator pressure dropping below a threshold. As a result, the electronic solenoid valve 390 in the first position may facilitate the flow of fluid from the supply valve 370 to the brake valve 440. The electronic solenoid valve 390 may also have a flow path leading from a port of the electronic solenoid valve 390 to the tank 280.

The inverse shuttle valve 420 can include a plurality of equal pressure valves connected to each the first accumulator 320 and the second accumulator 330. The plurality of equal pressure valves are operable to allow the fluid flow from the pump 300 to enter and fill or charge each the first accumulator 320 and the second accumulator 330. The plurality of equal pressure valves act to equalize the flow of fluid to each the first accumulator 320 and the second accumulator 330 by maintaining an equal pressure within each of the first accumulator 320 and the second accumulator 330.

The relief valve 410 is coupled to another branch line that is extended between the fluid flow path 310 downstream of the check valve 400 and to the tank 280. The relief valve 410 allows the fluid to pass from an area of higher pressure to an area of lower pressure. The relief valve 410 connects the interior of the supply valve 370 to the tank 280. When the pressure of the system reaches a predetermined pressure threshold within the supply valve 370, the relief valve 410 shifts to its relief position to dump to the tank 280.

One or more pressure sensors (shown as a first pressure sensor 450 and a second pressure sensor 460) can be coupled to the fluid flow path 310. The controller 210 is in communication with the pressure sensors 450 and 460 and receives as inputs the pressure signals indicative of the accumulator pressure. The first pressure sensor 450 may be operative to measure and report the pressure within both the first accumulator 320 and the second accumulator 330. The first pressure sensor 450 reads the pressure of both the first accumulator 320 and the second accumulator 330 as the plurality of equal pressure valves operates to equalize the pressure within both of the accumulators 320 and 330. Additionally, a second pressure sensor 460 may be present. The second pressure sensor 460 provides the same functionality as the first pressure sensor 450, and operates as a redundancy option in case failure occurs within the first pressure sensor 450. The first accumulator 320 may be responsible for braking the front axle 482 of the work machine 120. In the same regard, the second accumulator 330 may be responsible for braking the rear axle 484 of the work machine 120. Furthermore, both the first pressure sensor 450 and the second pressure sensor 460 may measure and report the pressure drop which occurs when an amount of fluid is released from both the first accumulator 320 and the second accumulator 330 during a braking action performed by the work machine 120. This pressure drop may be noticed by the controller 210 of the work machine 120 indicating that a braking action has occurred. Moreover, both the first pressure sensor 450 and the second pressure sensor 460 may connect to the controller 210. The first pressure sensor 450 and the second pressure sensor 460 may, respectively, send a first reporting signal 470 and a second reporting signal 480 to the controller 210 regarding the information each the first pressure sensor 450 and the second pressure sensor 460 has received regarding the first accumulator 320 and the second accumulator 330.

Each of the first accumulator 320 and the second accumulator 330 may be capable of receiving the flow of fluid from the pump 300 to build up pressure within each the first accumulator 320 and the second accumulator 330. The fluid within each the first accumulator 320 and the second accumulator 330 may be held within each of the respective accumulators 320 and 330 at a predetermined pressure value for operable braking of the work machine 120 during a braking action.

The first accumulator 320 and the second accumulator 330 connect to a first brake control valve 490 and a second brake control valve 500, respectively. The first brake control valve 490 may in turn be connected to the second brake control valve 500. The second brake control valve 500 may also be configured to receive an input from a user of the work machine 120. For example, this input may be a brake pedal 250 connected to second brake control valve 500. When the brake pedal 250 is depressed by a user of the work machine 120, pressurized fluid from each the first accumulator 320 and the second accumulator 330 flows to the first brake control valve 490 and the second brake control valve 500 to facilitate braking of the work machine 120.

Furthermore, the first brake control valve 490 and the second brake control valve 500 connect to each a first brake actuator system 510 and a second brake actuator system 520. As the first brake control valve 490 is responsible for braking the front axle 482 of the work machine 120, the first brake control valve 490 connects to the first brake actuator system 510. The first brake actuator system 510 has a right front brake actuator 512 to apply a right front braking mechanism 514 to the right front wheel of the front axle 482 during the braking action. Additionally, the first brake actuator system 510 may have a left front brake actuator 516 to apply a left front braking mechanism 518 to the left front wheel of the front axle 482 during the braking action. Each the right front braking mechanism 514 and the left front braking mechanism 518 may be a drum brake or a disc brake. The fluid flow through the first brake control valve 490 to the first brake actuator system 510 is maintained by the first accumulator 320. Furthermore, a right front pressure sensor 513 may attach to the fluid flow path connecting the first brake control valve 490 to the right front braking actuator 512. In the same regard, a left front pressure sensor 515 may attach to the fluid flow path connecting the first brake control valve 490 to the left front braking actuator 516. Both the right front pressure sensor 513 and the left front pressure sensor 515 may be configured to measure and report the pressure of the fluid within each the right front braking actuator 512 and the left front braking actuator 516 when the respective actuators 512 and 516 are active in producing the braking action. The right front pressure sensor 513 and the left front pressure sensor 515 may be report their respective pressure measurements back to the controller 210 for individual brake mechanism 514 or 518 wear calculations.

Furthermore, as the second brake control valve 500 is responsible for braking the rear axle 484 of the work machine 120, the second brake control valve 500 connects to the second brake actuator system 520. The second brake actuator system 520 may have a right rear braking actuator 522 to apply a right rear braking mechanism 524 to the right rear wheel of the rear axle 484 during the braking action. Additionally, the second brake actuator system 520 may have a left rear braking actuator 526 to apply a left rear braking mechanism 528 to the left rear wheel of the rear axle 484 during the braking action. Each the right rear braking mechanism and the left rear braking mechanism may be a drum brake or a disc brake. The fluid flow through the second brake control valve 500 to the second brake actuator system 520 is maintained by the second accumulator 330. Additionally, a right rear pressure sensor 523 may attach to the fluid flow path 310 connecting the second brake control valve 500 to the right rear braking actuator 522. In the same regard, a left rear pressure sensor 525 may attach to the fluid flow path connecting the second brake control valve 500 to the left rear braking actuator 526. Both the right rear pressure sensor 523 and the left rear pressure sensor 525 may be configured to measure and report the pressure of the fluid within each the right rear braking actuator 522 and the left rear braking actuator 526 when the respective actuators 522 and 526 are active in producing the braking action. The right rear pressure sensor 523 and the left rear pressure sensor 525 may be report their respective pressure measurements back to the controller 210 for individual brake mechanism 524 or 528 wear calculations.

Each the first brake actuator system 510 and the second brake actuator system 520 are configured to selectively actuate their respective braking mechanisms 514, 518, 524 or 528 based on the fluid pressure maintained within each the right and left front braking actuators 512 and 516 and the right and left rear braking actuator 522 and 526. Depending on the actuation of the braking mechanisms 514, 518, 524 or 528 attached to the wheels 230 and 240 of the front axle 482 and rear axle 484, the braking action will occur gradually or quickly in relation to the fluid pressure provided within each the first brake actuator system 510 and the second brake actuator system 520.

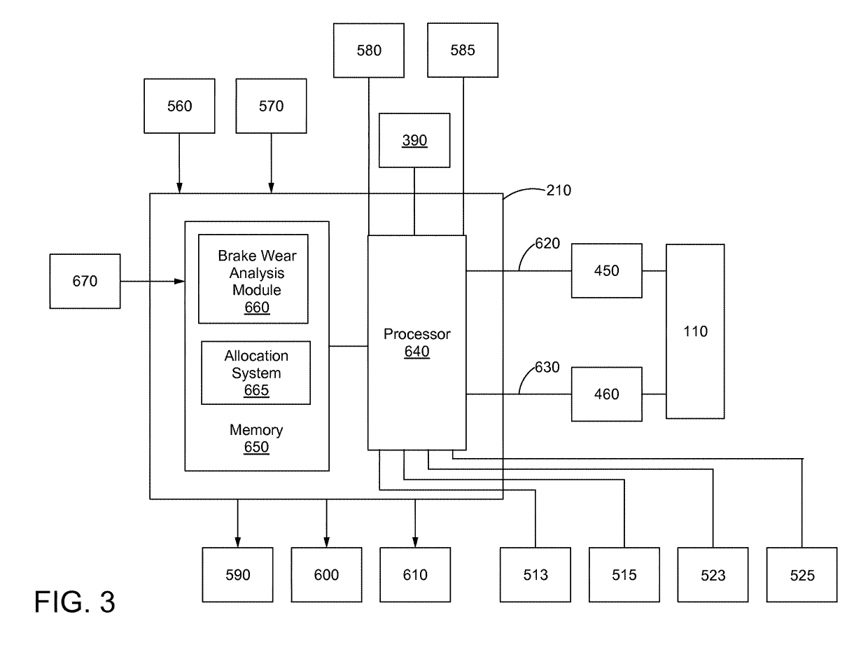

Referring now to FIG. 3, the controller 210 of the work machine 120 is depicted in greater detail. The controller 210 electrically connects to the control elements of the work machine 120, as well as various input devices for commanding the operation of the work machine 120 and monitoring their performance. To perform such tasks, the controller 210 may be electrically connected to input devices which detect user input. Such input devices may include but are not limited to: a brake control system 560 operably connected to detect displacement of a brake pedal 250, and a parking brake control system 570 to detect actuation of a parking brake device by a user. Additionally, the controller 210 may be able to send outputs and notifications to the user. While the user is situated within the operator station 145, a display screen 590 may be present to notify the user of communications coming from the controller. Furthermore, indicators 600 or status lights 610 may also be present within the operator station 145 to receive output communications from the controller 210. The display screen 590, indicators 600, and/or status lights 610 may be operable to communicate to the user work machine operations such as parking brake engagement, fuel levels, engine health, brake system health, hydraulic system health, and any other types of notifications which may benefit the user of the work machine 120.

The controller 210, as stated earlier and viewed in FIG. 3, connects to both the first pressure sensor 450 and the second pressure sensor 460 of the brake charge system 110 via a first data transmission line 620 and a second data transmission line 630. The first data transmission line 620 and the second data transmission line 630 are operable to allow communication including the first reporting signal 470 and the second reporting signal 480 between the controller 210 and the first pressure sensor 450 and the second pressure sensor 460 of the brake charge system 110. In this fashion, the controller 210 can help assess the health of the brake charge system 110 of the work machine 120.

The first data transmission line 620 and the second data transmission line 630 connect to a processor 640 which is contained within the controller 210 of the work machine 120. The processor 640 can be any of a microprocessor, microcomputer, application-specific integrated circuit, or the like. For example, the processor 640 can be implemented by one or more microprocessors or controllers within an integrated circuit design. The processor 640 may be used to execute specified programs stored within a memory 650 of the controller 210 to control and monitor the various functions associated with the work machine 120.

Similarly, a memory 650 or non-transitory storage medium may reside on the same integrated circuit as the processor 640 within the controller 210. The memory 650 may include a random access memory (i.e., Synchronous Dynamic Random Access Memory (SDRAM), Dynamic Random Access Memory (DRAM), RAMBUS Dynamic Random Access Memory (RDRAM) or any other type of random access memory device or system). Additionally or alternatively, the memory 650 or non-transitory storage medium may include a read only memory (i.e., a hard drive, flash memory, EPROM, or any other desired type of memory device).

The information that is stored by the memory 650 can include program modules associated with one or more systems of the work machine 120 as well as informational data relating to the work machine 120. The program modules are typically implemented via executable instructions stored in memory 650 to control basic functions of the controller 210 and its interaction with the systems of the work machine 120. These functions may include interaction among various system components of the work machine 120 and storage, retrieval, and processing of system component data to and from the memory 650.

With respect to the program modules stored within the memory 650, these utilize the processor 640 to provide a more specific functionality of the system information received by the controller 210. In an embodiment of the present disclosure, the brake wear analysis system 100 includes a brake wear analysis module 660 located within the memory 650 of the controller 210. This brake wear analysis module 660 may be loaded into the memory 650 of the controller 210 through a device input 670 of the controller 210. The device input 670 of the controller 210 may connect to the operator station 145 of the work machine 120 or be accessible by maintenance personal performing work on the controller 210.

The brake wear analysis module 660 may be an executable program stored within the memory 650 of the controller 210 operable to determine and report the wear condition of a physical braking component used within a work machine 120. The brake wear analysis module 660 communicates with the brake system 200, and more specifically the brake charge system 110, through the first pressure sensor 450 and the second pressure sensor 460. The brake wear analysis module 660 receives the first reporting signal 470 from the first pressure sensor 450 and the second reporting signal 480 from the second pressure sensor 460. The information contained within each the first reporting signal 470 and second reporting signal 480 can include pressure data for both the first accumulator 320 and second accumulator 330. The volume of fluid charged within each accumulator is calculated when pressure changes are detected during the braking action. Additionally, the brake wear analysis module 660 may connect through the processor 640 to a pedal sensor 580 used to communicate that the brake pedal 250 has been depressed by the operator to command a braking action. Furthermore, the brake wear analysis module 660 may connect through the processor 640 and communicate with a charge input command of the electronic solenoid valve 390 to know when the electronic solenoid valve 390 is charging as this will change the pressure within each the first accumulator 320 and the second accumulator 330. Moreover, the brake wear analysis module 660 may also connect through the processor 640 and communicate with a parking brake valve 585. Use of the parking brake valve 585 will cause a change in the pressure within each the first accumulator 320 and the second accumulator 330 in some work machines 120. However, when it is indicated that the parking brake valve 585 is in use, the brake wear analysis module 660 should not use this change in accumulator pressure to determine the wear condition of the braking system 200.

The brake wear analysis module 660 may additionally have an allocation system 665 contained within the brake wear analysis module 660. The allocation system 665 would be operative to calculate the volume of fluid charged within each actuator 512, 516, 522 and 526 when a braking action is detected. Inputs from the right front pressure sensor 513, left front pressure sensor 515, right rear pressure sensor 523, and left rear pressure sensor 525 may report through the processor 640, within the controller 210, the pressures used to activate their respective braking mechanisms 514, 518, 524, or 528 on the work machine 120 to the allocation system 665. Within the allocation system 665, the volume of fluid used within each respective braking actuator 512, 516. 522 and 526 can then be calculated by the allocation system 665. The calculation of fluid volume used in each braking mechanism 514, 518, 524, and 528 is an allocation of the total fluid volume used from the braking action based on the information collected by the individual pressure sensors 513, 515, 523, and 525. The amount of time that passes from when a brake command is inputted to when the pressure rises within each braking actuator 512, 516, 522, and 526 indicated a fraction of the total fluid volume used. In an ideal wear scenario, volume of fluid charged within the accumulators 320 and 330 would be equally distributed between each respective braking actuator 512, 516, 522, and 526. The allocation system 665 may then report its calculated results to the brake wear analysis module 660. Just as the total fluid volume can be compared to an expected value, the allocated fluid volumes for each braking actuator 512, 516, 524, and 526 can be compared to an expected allocated fluid volume for each braking mechanism 514, 518, 524, and 528. The brake wear analysis module 660 may then in turn produce an output to either the display screen 590, indicators 600, and/or status lights 610 within the operator station 145 showing which of the individual braking mechanisms 514, 518, 524, or 528 is experiencing the greater amount of wear and on an individual basis, and notify the operator which braking mechanism 514, 518, 524, or 528 is approaching a worn out condition.

The brake wear analysis module 660 of the present disclosure provides a standardized continuous method to check the wear accrued on the braking mechanism 514, 518, 524 or 528 without intervention by a maintenance technician. Additionally, the brake wear analysis module 660 provides a braking calculation for each braking action taken by the work machine 120. This real-time analysis can be used to alert the operator of the work machine 120 if the braking mechanism 514, 518, 524 or 528 has become compromised by being in a worn condition. To perform a braking calculation for each braking action, the brake wear analysis module 660 records the pressure change in the accumulators 320 and 330 during the time it takes to complete the braking action. The volume of fluid charged within the accumulators 320 and 330 is then calculated from the observed pressure change. The amount of fluid used in the braking action is then compared to a predetermined threshold level to determine if the amount of fluid used either exceeds or falls short of that predetermined threshold level. If the amount of fluid used in the braking action exceeds the predetermined threshold level, the brake wear analysis module 660 determines that the braking mechanism 514, 518, 524 or 528 of the work machine 120 is sufficiently worn and a replacement may be needed. The predetermined threshold level is determined by design parameters and development testing of the brake wear analysis module 660 with a worn braking mechanism. As the braking mechanism 514, 518, 524 or 528 wears, more and more fluid is needed to complete the braking action. This causes an increase in fluid flow from the accumulator 320 or 330 to the braking actuators 512, 516, 522, or 526. A new braking mechanism 514, 518, 524 or 528 will require a minimal drop in fluid volume within the accumulator 320 or 330 to perform the braking action. However, a worn braking mechanism 514, 518, 524 or 528 will require a greater drop in fluid volume within the accumulator 320 or 330 to perform the same braking action as a greater amount of time and actuator travel is needed for contact between the braking mechanism 514, 518, 524 or 528 and the wheels 230/240 or axle 482/484 to slow the work machine 120.

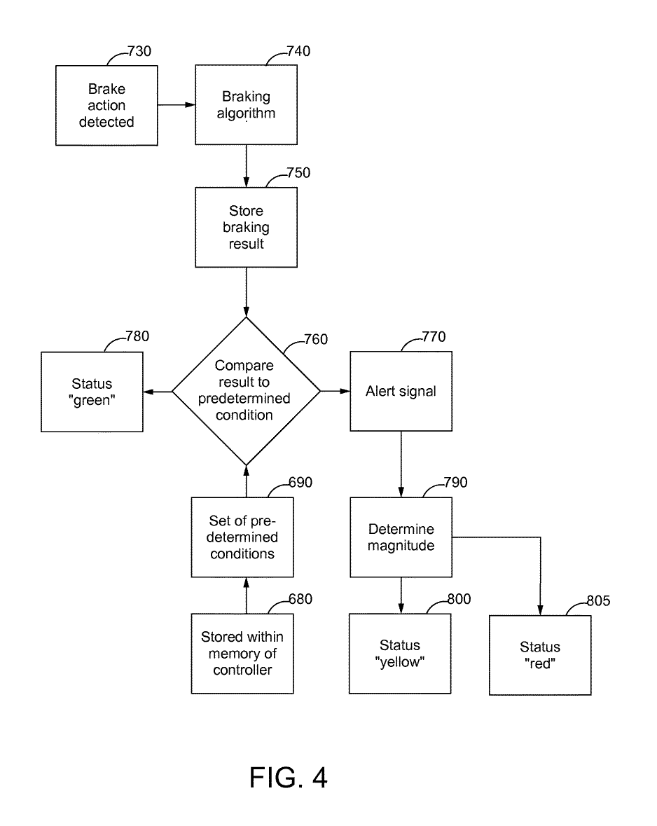

Referring now to FIG. 4, a flow chart is depicted showing an exemplary set of steps which may be practiced for the brake wear analysis module 660 to function. First, as seen in block 680, the brake wear analysis module 660 is stored within the memory 650 of the controller 210 of the work machine 120. This can be accomplished by a user uploading the brake wear analysis module 660 through a device input 670 located on either the controller 210 or within the operator station 145 of the work machine 120. Contained within the brake wear analysis module 660 is a set of predetermined conditions 690. This set of predetermined conditions 690 takes into consideration the multiple variables used by the brake wear analysis module 660. As the brake wear analysis module 660 may be used on any work machine 120, the set of predetermined conditions 690 might include fluid volume of the accumulators 320 and 330 used on that work machine 120, the type of braking mechanism 514, 518, 524 or 528 employed by that work machine 120, and predetermined expected wear points of the braking mechanism 514, 518, 524 or 528 determined by testing with that work machine 120.

As long as the set of predetermined conditions are detected and verified, the brake wear analysis module 660 operates whenever the work machine 120 is in use. As the work machine 120 operates, the brake wear analysis module 660 continuously monitors the pressure sensors 450 and 460 of the brake charge system 110 for any variation in pressure. Then, in block 730, a braking action is detected when a decrease of accumulator pressure is observed typically in conjunction with input from the pedal sensor 580. This indicates to the brake wear analysis module 660 that a braking action is occurring.

To determine the amount of fluid used in a single braking action, a braking algorithm is used in block 740. The braking algorithm is a volume calculation algorithm which includes solving a nonadbiatic process control equation and the gas law for the brake charge system 110 simultaneously at a given ambient temperature of the accumulators 320 and 330. The nonadbiatic process control equation and the gas law for the brake charge system 110 can be viewed below.

Nonadbiatic Process Control Equation PV^{γ}=[PV^{γ}]ₜ₀e^{∫}^{ₜ₀}^{^{t}}^{(T}^{_{w}}^{/T-1)/τdt}

Gas Law PV=mRT

Regarding the gas law, P equals the pressure of the gas within the accumulator 320 and 330, V equals the volume of the gas within the accumulator 320 and 330, T equals the absolute temperature of the gas within the accumulator 320 and 330, and R is the universal gas constant. The variable m refers to the mass of the gas within the accumulator 320 or 330. For the nonadbiatic process control equation a few additional variables are present. In the nonadbiatic process control equation, the time from t₀ to t represents the cutout setting. T_{w} refers to the ambient temperature of the gas of the accumulator 320 or 330, and τ (tau) refers to the accumulator time constant. Also, the exponent γ (gamma) represents the nitrogen gas constant of the accumulator 320 or 330. By completing these two equations, the nonadbiatic process control equation provides a reasonable estimate of the fluid charged into the accumulator 320 or 330 during a charge event.

The nonadbiatic process control equation is a unique mathematical equation developed by the inventors through their study of the accumulators 320 or 330 employed within work machines 120. The nonadbiatic process control equation expands upon an initial equation relating to the thermal time constant model developed by A. Pourmovahed and D. R. Otis. Information relating to the development and use of the thermal time constant model is hereby incorporated by reference with the scholarly article, An Experimental Thermal Time-Constant Correlation for Hydraulic Accumulators published by A. Pourmovahed and D. R. Otis within the American Society of Mechanical Engineers' Journal of Dynamic Systems, Measurement, and Control, Vol. 112, March 1990. In addition to utilizing this equation, the inventors further developed the nonadbiatic process control equation by developing the control equation parameters of specific work machines 120, and treating the nitrogen gas within the accumulators 320 and 330 as an ideal gas. During a charge event of the brake charge system 110, fluid is added into the accumulator 320 and 330. When a braking action occurs on the work machine 120, fluid is removed from the accumulator 320 and 330 as a result of the braking action. The nonadbiatic process control equation provides a reasonable estimate of either the fluid added or removed. As explained in Pourmovahed and Otis's research, the accumulator thermal constant tau can be found experimentally for the accumulator 320 or 330 and for a specified range of operation. Once tau is known, the nonadbiatic process control equation is used to evaluate how much fluid is removed with each braking action.

Then in block 750, the braking result from the braking algorithm is stored within the brake wear analysis module 660. Next in block 760, the braking result is compared to the predetermined condition 690 within the brake wear analysis module 660. The calculated volume of a braking action is compared to the predetermined condition 690 that represents the volume of a worn brake, or more specifically as envisioned; an average of many calculated volumes from multiple braking actions is compared to the volume of a worn brake. This comparison of the calculated average against the volume of the worn brake determines the wear condition of the braking mechanism 514, 518, 524, and 528 evaluated.

Then in block 770, if the average calculated exceeds the volume of a worn brake (or perhaps approaches the theoretical value for volume of a worn brake) then an alert signal may be sent to the operator station 145. If, however, the average calculated is less than the volume of a worn brake, the brake wear analysis module 660 may not generate or report any type of signal and return to monitoring the work machine 120 until another braking action is detected. In other embodiments, the brake wear analysis module 660 may generate an operational status if the average calculated is less than the volume of a worn brake. If the average calculated is less than the volume of a worn brake, and the average calculated is determined with confidence in its accuracy, an indicator 600 could be displayed within the operator station telling the operator the amount of braking material which remains on the braking mechanism 514, 518, 524, and 528. In another embodiment, if the average calculated is less than the volume of a worn brake, and the average calculated is determined without confidence in its accuracy, a green light emitting diode (LED) 780 or the like indicator 600 may illuminate notifying the operator that the braking mechanisms 514, 518, 524, and 528 are operationally functional in comparison with the worn condition.

In alternate embodiments of the present disclosure, the alert signal to alert the user to worn brakes may not occur only when the brakes have entered a predetermined worn state. Since each braking action allows for the volume of fluid leaving the accumulator 320 and 330 to be recorded and stored, multiple alerts may be transmitted to the user in the operator station 145 regarding the health of the braking system 200. In one such exemplary embodiment, the user in the operator station 145 may receive a maintenance soon alert if the volume of fluid discharged from the accumulator 320 or 330 has not yet reached the predetermined worn status, but is sufficiently close for an alert to trigger thereby notifying the operator. In this respect, the magnitude 790 of the comparison between the average calculated and the volume of a worn brake determines the state of the alert outputted to the operator. Furthermore, the brake wear analysis module 660 may alert the operator after every braking action occurs. In this envisioned embodiment, the braking system alert may have indicators 600 to notify the user in the operator station 145 of the status of the braking system 200 based on the brake wear analysis module 660. For example, if the brake wear analysis module 660 reports that the fluid discharged from the accumulator 320 and 330 is within normal operation ranges based on the set of predetermined conditions, a green LED 780 or the like may illuminate to notify the operator that the braking system 200 is working correctly. If, however, the brake wear analysis module 660 reports that the fluid discharged from the accumulator 320 or 330 does not yet exceed the worn brake range, but is near the worn brake range based on the set of predetermined conditions, a yellow LED 800 or the like may illuminate to notify the operator that the braking system 200 will soon require maintenance. Finally, if the brake wear analysis module 660 reports that the fluid discharged from the accumulators 320 and 330 exceeds the worn brake range based on the set of predetermined conditions, a red LED 805 or the like may illuminate to notify the operator that the braking system 200 requires immediate attention and maintenance.

### INDUSTRIAL APPLICABILITY

From the foregoing, it may be appreciated that the brake wear analysis system disclosed herein may have applicability in a variety of industries such as, but not limited to, use in work machines or any type of machine which employs a hydraulic braking system with hydraulic accumulators. Furthermore, the brake wear analysis system may be used in any industrial system where accumulators are used as the actuating source of fluid and the actuator, or the device moved by the actuator, has a wear condition to be monitored. Such a brake wear analysis system removes traditional routine inspection techniques by maintenance workers and allows technicians to only service the brake system of work machines when actual wear of the brake mechanism has been detected. This results in less downtime and increased productivity for both the maintenance technicians and the operator of the work machine. Additionally, it would be advantageous to create such a brake wear analysis system through modifications to the preexisting components of the braking system, thereby not endangering the functionality of the braking system with newly introduced components or devices. Having such a brake wear analysis system which can monitor the braking system of a work machine, and determine the wear status of the physical components of the braking system would be extremely useful and beneficial to all operators, maintenance technicians and companies owning the work machines. Furthermore, such a brake wear analysis system provides real time feed back to the user/operator as the work machine operates. This reduces that chance that faults within the brake system will catastrophically occur between maintenance cycles as well as easily identifies brake system issues that must be addressed for safe operation of the work machine. Moreover, the disclosed brake wear analysis system can be employed in any type of industry that facilitates the use work machines. Such industries may include mining, construction, farming, transportation, police and military work machines, recreational off-road machines, rail, agriculture, shipbuilding equipment, drainage and sewer maintenance machines, underwater maintenance machines or any like environment in which a work machine utilizing hydraulic braking may be needed or operated.

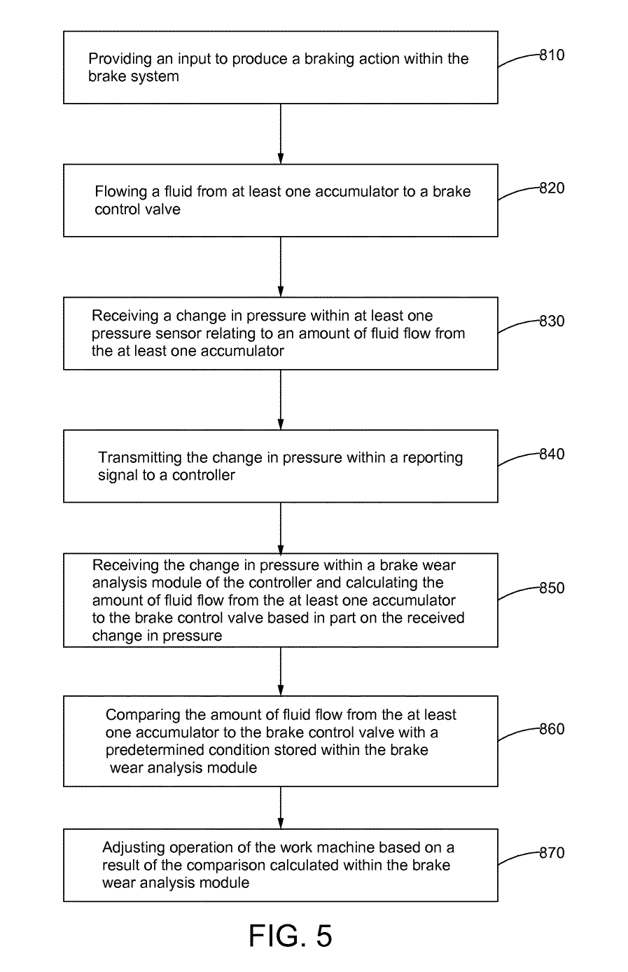

An exemplary method to determine the wear of the brake system 200 according to the present disclosure is shown in flow chart format within FIG. 5. As shown in a block 810, an input is provided to produce a braking action within the brake system 200 of the work machine 120. This input may be a user initiated input such as, but not limited to depressing the brake pedal 250 within the operator station 145 of the work machine 120. Then in a block 820, fluid flows from at least one accumulator 320 or 330 to the brake control valve 490 or 500 based on the provided input. Hydraulic fluid is discharged from the accumulator 320 or 330 and sent to the brake control valve 490 or 500 based on the initiation of a braking action. Next in a block 830, a drop in pressure corresponding to the amount of fluid flow from the at least one accumulator 320 or 330 to the brake control valve 490 or 500 is received within at least one pressure sensor 450 or 460 of the brake system 200.

Then in a block 840, the drop in pressure detected is transmitted to the controller 210 of the work machine 120 via a reporting signal 470 or 480. Afterwards, in a block 850, the drop in pressure detected is received by the brake wear analysis module 660 within the controller 210 and the volume of fluid consumed by the braking action is calculated. The brake wear analysis module 660 stores the results of the braking algorithm, or volume calculation algorithm, and uses that data for later calculations. Next, in a block 860, the amount of fluid flow from the at least one accumulator 320 or 330 to the brake control valve 490 or 500 is compared with a predetermined condition 690 stored within the brake wear analysis module 660. The predetermined condition in this embodiment of the present disclosure is a calculation of the expected amount of fluid flow which would be discharged during a braking action with a worn braking mechanism. This expected amount of fluid flow may be stored within the brake wear analysis module 660 for this comparison. This expected amount of fluid flow is then compared with the amount of fluid flow obtained from the braking algorithm or volume calculation algorithm. Finally, the operation of the work machine 120 is adjusted in a block 870 based on a result of the comparison calculated within the brake wear analysis module 660 of the controller 210. In this final step, an additional output signal such as the alert signal may be transmitted from the controller 210 to the indicator 600 within the operator station 145, thereby letting the operator know the status of the braking system 200 based on the results calculated by the brake wear analysis module 660.

While the foregoing detailed description addresses only specific embodiments, it is to be understood that the scope of the disclosure is not intended to be limited thereby. Rather, the breadth and spirit of this disclosure is intended to be broader than any of the embodiments specifically disclosed.

What is claimed is:

1. A brake system for use on a work machine, the brake system comprising:
a brake charge system;
at least one accumulator connected to the brake charge system, the at least one accumulator able to store a pressurized fluid received from the brake charge system;
a brake control valve able to receive the stored pressurized fluid from the at least one accumulator based on an input indicative of a braking action;
at least one pressure sensor fluidly coupled to the brake charge system to indicate an accumulator pressure of the pressurized fluid of the at least one accumulator; and
a controller electronically connected to the at least one pressure sensor, the controller having a braking algorithm and a brake wear analysis module, the controller configured to:
receive a pressure signal from the at least one pressure sensor and determine the accumulator pressure in response to the input indicative of the braking action;
determine an estimated volume of fluid received by the brake control valve with the braking algorithm based on the determined accumulator pressure; and
compare the estimated volume with a predetermined threshold indicative of nominal worn brake volume with the brake wear analysis module.

2. The brake system of claim 1, wherein the braking algorithm utilizes a gas law equation and a nonadbiatic process control equation to determine the estimated volume of fluid received by the brake control valve.

3. The brake system of claim 2, wherein the brake wear analysis module utilizes the estimated volume of fluid received by the brake control valve and the predetermined threshold indicative of nominal worn brake volume to determine a wear condition of a braking mechanism.

4. The brake system of claim 1, wherein the controller further includes an allocation system.

5. The brake system of claim 4, wherein the controller is further configured to:
receive an actuator pressure from an actuator pressure sensor connected to a braking actuator of the braking system;
allocate a total volume of fluid used to each braking actuator employed within the braking system, the allocation based upon the actuator pressure information; and
determine if a braking mechanism connected to the braking actuator is in a wear condition, the wear condition based upon a comparison of the allocated total volume of fluid used to an expected volume of fluid used with a worn braking mechanism.

6. The brake system of claim 1, wherein the controller is further configured to:
output a wear condition of the braking system, the wear condition considered good if the comparison shows that the estimated volume of the fluid received by the brake control valve is greater than the predetermined threshold indicative of nominal worn brake volume.

7. The brake system of claim 1, wherein the controller is further configured to:
output a wear condition of the braking system, the wear condition considered fair if the comparison shows that the estimated volume of the fluid received by the brake control valve is greater than the predetermined threshold indicative of nominal worn brake volume, yet the estimated volume of fluid flow is less than a predetermined threshold fluid volume indicative of the fair wear condition.

8. The brake system of claim 1, wherein the controller is further configured to:
output a wear condition of the braking system, the wear condition considered poor if the comparison shows that the estimated volume of the fluid received by the brake control valve is less than the predetermined threshold indicative of nominal worn brake volume.

9. A work machine comprising:
a frame;
an operator station supported by the frame;
a power source supported by the frame;
a drive system operatively connected to the power source;
a brake system operatively associated with the drive system, the brake system having at least one accumulator connected to a brake charge system, the at least one accumulator able to receive and hold a fluid from the brake charge system, a brake control valve able to receive the fluid from the at least one accumulator based on an input received within the operator station and at least one pressure sensor connected to the brake charge system able to receive and transmit information regarding a braking action applied to the drive system; and
a controller electronically connected to the at least one pressure sensor, the controller having a brake wear analysis module configured to receive and interpret the information regarding the braking action applied to the drive system sent from the at least one pressure sensor.

10. The work machine of claim 9, wherein the at least one accumulator is a first accumulator and a second accumulator of a plurality of accumulators, the first accumulator providing a first flow of fluid regarding the braking action of a front axle of the drive system and the second accumulator providing a second flow of fluid regarding the braking action of a rear axle of the drive system.

11. The work machine of claim 9, wherein the brake control valve connects to a braking actuator, the braking actuator able to receive the fluid from the at least one accumulator to activate a braking mechanism to physically brake the drive system.

12. The work machine of claim 11, wherein the information regarding the braking action includes a change in pressure within the at least one accumulator when an amount of fluid is released to the braking actuator to activate the braking mechanism.

13. The work machine of claim 12, wherein the controller includes a processor and a memory, the brake wear analysis module contained within the memory of the controller and having an allocation system.

14. The work machine of claim 13, wherein the allocation system receives an actuator pressure from an actuator pressure sensor connected to the braking actuator, the actuator pressure from the actuator pressure sensor used to calculate a wear condition of the braking member connected to the braking actuator within the allocation system.

15. The work machine of claim 13, wherein the brake wear analysis module contains at least one predetermined condition stored within the memory of the controller, the predetermined condition relating to either the at least one accumulator, the braking mechanism or the amount of fluid released from the at least one accumulator, the brake wear analysis module calculating a wear condition of the braking mechanism through use of a nonadbiatic process control equation, a gas law, and the predetermined condition.

16. The work machine of claim 15, wherein the brake wear analysis module produces an output signal sent to an indicator within the operator station, the indicator displaying a health status of the brake system.

17. The work machine of claim 9, wherein the brake wear analysis module within the controller is also electronically connected to each a pedal sensor, a charging valve within the brake charge system, and a parking brake valve.

18. A method to determine the wear of a brake system, the method comprising:
providing an input to activate a braking action within a brake system of a work machine,
providing a fluid from at least one accumulator to a brake control valve based on the provided input;
receiving an accumulator pressure with at least one pressure sensor based on the provided input;
determining a change in the accumulator pressure with a controller as a result of the provided input;
determining a change in volume of the amount of fluid flow from the at least one accumulator to the brake control valve with a brake wear analysis module of the controller based in part on the determined change in accumulator pressure; and
comparing the amount of fluid flow from the at least one accumulator to the brake control valve with a predetermined condition stored within the brake wear analysis module.

19. The method of claim 18, wherein the brake wear analysis module performs a calculation of an expected amount of fluid flow from the at least one accumulator to the brake control valve based on a nonadbiatic process control equation stored within the brake wear analysis module.

20. The method of claim 19, wherein the method further comprises adjusting operation of the work machine based on a result of the comparison by transmitting an output signal to an indicator within an operator station of the work machine.
